(19) United States
(12) Patent Application Publication
(10) Pub. No.: US 2003/0091776 A1
(43) Pub. Date: May 15, 2003

(54) Tubular thermoinsulating device and processes for the manufacture thereof

(75) Inventors: Pierattilio Di Gregorio, Sulmona (IT); Marco Della Rocca, Avezzano (IT); Manuel Pulsoni, Avezzano (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SAES GETTERS S.p.A.

(21) Appl. No.: 10/321,152

(22) Filed: Dec. 18, 2002

Related U.S. Application Data
(63) Continuation of application No. PCT/IT02/00144, filed on Mar. 7, 2002.

(30) Foreign Application Priority Data
Mar. 9, 2001 (IT) MI2001A 000513
Sep. 19, 2002 (WO) 02/073082 A1

(51) Int. Cl. B32B 1/08

(52) U.S. Cl. 428/36.91; 428/69; 428/71

(57) ABSTRACT

The present invention relates to a tubular thermoinsulating device (10; 20; 30), comprising an evacuated envelope made of barrier sheets inside which an inorganic or polymeric, discontinuous or porous filling material (13; 23) is contained. Said envelope comprises an internal tubular element (11; 21; 31) and an external tubular element (12; 22; 32) of higher diameter, which are coaxially arranged one inside the other and are reciprocally sealed at their circular edges. The circular edges of said external tubular element (12; 22; 32) are adapted to the circular edges of said internal tubular element (11; 21; 31) by means of two plies (17, 17′; 25, 25′; 35, 35′). The present invention also relates to some processes for manufacturing said thermoinsulating device.

The present invention relates to tubular devices for thermal insulation, and in particular it relates to an evacuated tubular thermoinsulating device as well as to some processes for the manufacture thereof.

Evacuated thermoinsulating devices are well known in the form of flat panels, which are being increasingly used in all the fields wherein thermal insulation of substantially parallelepipedal bodies is required. The walls of household and industrial refrigerators, of beverages vending machines or of containers for isothermal transport, for example of medicines or cold or frozen food are examples of application of these panels. Applications of these panels also in the building field or in the car industry are being studied.

As it is known, an evacuated panel is formed of an envelope wherein a filling material under vacuum is provided. The envelope has the purpose of preventing (or reducing as much as possible) the entrance of atmospheric gases inside the panel, so as to maintain a vacuum level compatible with the degree of thermal insulation required by that application. For this purpose, the envelope is made with so-called “barrier” sheets, characterized by a gas permeability which is as reduced as possible, which can be formed of a single component but more commonly are multilayers of different components. In the case of the multilayers the “barrier” effect is conferred by one of the component layers, whereas the other layers generally have functions of mechanical support and protection of the barrier layer.

The filling material has mainly the function of spacing apart the two opposite faces of the envelope when the vacuum is created inside the panel, and must have a porous or discontinuous internal structure so that the porosities or the interstices thereof can be evacuated in order to carry out the thermoinsulating function. This material can be inorganic, such as for example silica powder, glass fibers, aerogels, diatomaceous earths, etc.; or organic, such as rigid foams of polyurethane or polystyrene, both in the form of boards and of powders. Since the permeation of traces of atmospheric gases inside the panel is practically unavoidable, these panels contain in most cases also one or more materials (generally referred to as getter materials) which are able to sorb these gases, thus maintaining the pressure inside the panel at the desired values.

However, said thermoinsulating panel are not suitable for being curved and therefore for realizing the insulation of cylindrical or tubular bodies, such as the boilers or the pipes used in the arctic regions for transporting oil, which has to be maintained at the extraction temperature.

On the other side, until now evacuated devices of tubular shape which can house inside their cavity a cylindrical body, so as to insulate it in an optimal way, are not known. As a matter of fact, the manufacture of thermoinsulating devices having tubular shape involves a number of difficulties, among which the principal is the construction of an envelope having a high gas-tightness. The normal constructive approach would consist in first forming two tubular elements, suitable for forming the internal and external walls of the envelope (in the following also said internal sheet and external sheet), and subsequently, after having inserted between these elements a filling material and having carried out the evacuation, sealing the circular edges of said elements. However, this method is suitable for the manufacture of planar panels, wherein the two sheets which form the envelope have the same size, but it cannot be applied to the case of tubular thermoinsulating devices. As a matter of fact, in this case the two opposite faces of the device are concentric cylindrical surfaces, wherein the internal one has obviously a minor circumference with respect to the external one; consequently, in order to perfectly adhere to the internal and external faces of the device, also the two internal and external sheets must have different circumferences. However, in order to carry out the sealing of the envelope at the two circular bases of the device, it is necessary that these two sheets have the same circumference in the sealing zone. In order to solve the problem, an envelope could be formed with the internal sheet having the same circumference as the external sheet: however, in this case the internal sheet would not perfectly adhere to the internal surface of the filling material, with the formation of wrinkles which would have the double disadvantage that they might form areas of cracking of the barrier layer (generally an aluminum layer of the thickness of a few micrometers) thus compromising the features of impermeability to gases, and prevent the perfect adherence of the device to the surface of the body which has to be thermally insulated, thus reducing the efficiency of the insulation.

Another problem to be solved in order to manufacture tubular thermoinsulating devices is to find a way for carrying out the sealings at the circular bases of the device. A first possibility would be inserting into the tubular device which is being formed a hot circular member having a diameter corresponding to that of the internal sheet, and pressing against the sealing area two heated portions profiled as a “C”, so as to form a counter-mould for said hot member; this method has the disadvantage that the two heated “C” portions do not exert a uniform pressure on the whole circumference, so that the envelope sealing does not have a good tightness in the area of junction of the two “C” portions. Alternatively, it is possible to carry out the sealing by means of a number of subsequent punctual (or nearly punctual) weldings, but this method has the disadvantage that it requires rather a long time and therefore is not really industrially interesting.

The solutions which are known up to now for insulating cylindrical or tubular bodies do not solve the problem of manufacturing a tubular thermoinsulating device, but substantially avoid said problem, by proposing particular flat panels which can be curved or bent in order to be adapted to the lateral surfaces of said bodies.

For example, patent application PCT WO 96/32605 in the name of the British company ICI describes a process for bending panels which consists in making in the polymeric filling material, before the evacuation step, parallel grooves having width and depth proportional to the entity of the desired curvature. Subsequently, the thermoinsulating material is inserted into an envelope of traditional kind and the whole is subjected to the evacuation step, which causes the panels to bend along the grooves and to reach the final curved shape. Finally, the envelope is sealed. This process has the main disadvantage that the so produced panels do not cover in a continuous way the entire curved surface which has to be insulated and therefore the thermal insulation provided by them is not optimal. Further, the envelope by adhering to the filling material during the evacuation step, gets inserted at least partially inside the grooves, wherein it may be broken thus compromising forever the thermal insulation properties of the panel itself.

Object of the present invention is therefore to provide an evacuated thermoinsulating device of tubular shape. Said object is obtained with a device whose main features are specified in the first claim and other features are specified in the following claims, and which can be produced according to processes whose main features are specified in claims 9 and 11 and the additional features are specified in the following claims.

A first advantage of the thermoinsulating device according to the present invention consists in that the internal tubular element and the external tubular element which respectively form the internal and external walls of the envelope are sealed to each other at their circular edges in a perfect way and without wrinkles. As a matter of fact, the circular edges of the internal tubular element completely adhere to those of the external tubular element, and the exceeding parts of the edges of the latter are welded on themselves, thus forming two plies. In this way, the possibilities of permeation of the atmospheric gases inside the device through the sealings are extremely reduced.

Another advantage of the thermoinsulating device according to the present invention consists in that the internal surface thereof has no wrinkles, and therefore it can adhere perfectly to the cylindrical body (for example a petroleum pipe) around which it is arranged, thus allowing the optimal thermal insulation thereof.

An advantage of the manufacturing process according to the present invention consists in the possibility of carrying out at the same time the sealing of the circular edges of the internal and external tubular elements and the formation of said plies, in a simple and quick way, by means of thermo-welding with pairs of rectilinear welding bars of a conventional type.

Further advantages and features of the device according to the present invention will appear to those skilled in the art from the following detailed description of two embodiments thereof with reference to the accompanying drawings wherein:

FIG. 1 shows a perspective view of the thermoinsulating device according to a first embodiment of the present invention;

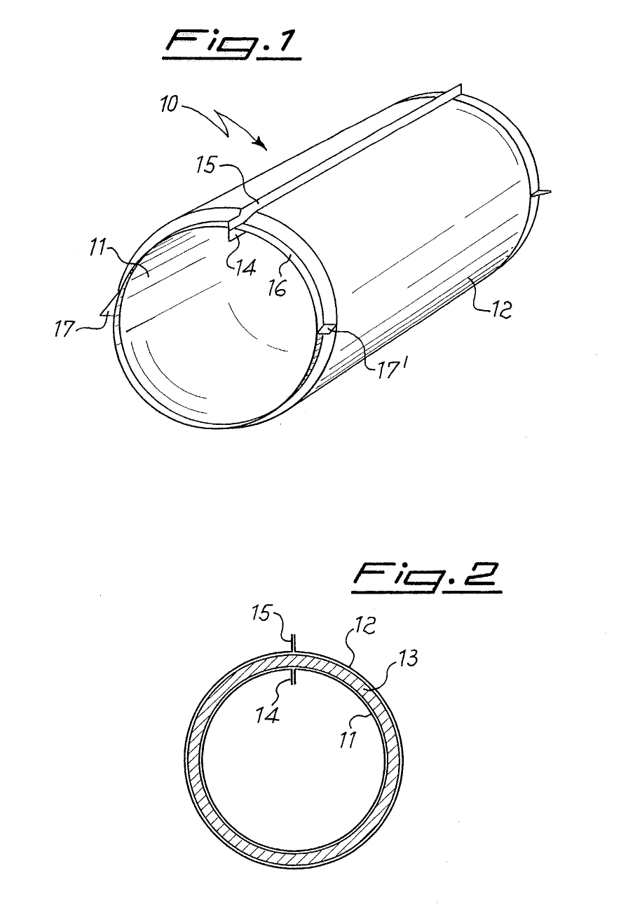

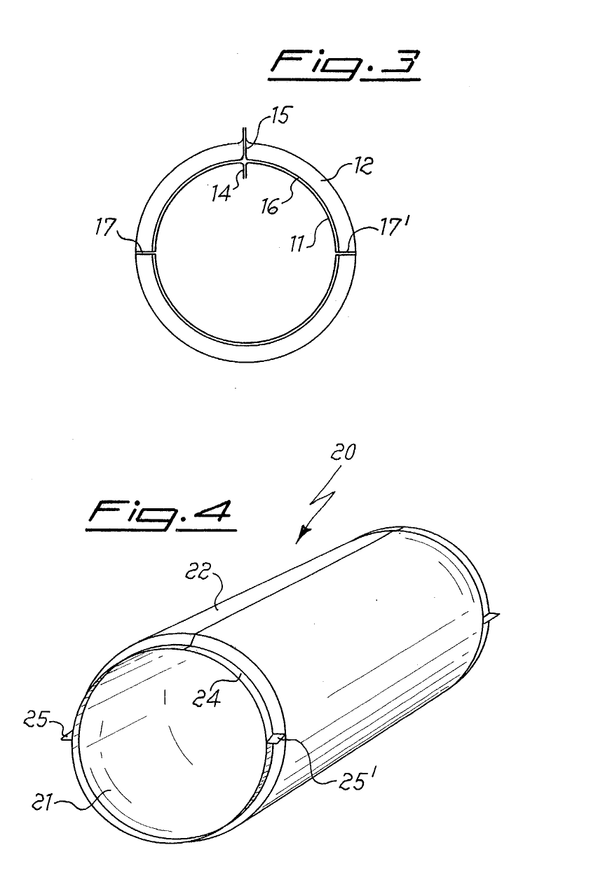

FIG. 2 shows a cross-sectional view of the thermoinsulating device of claim 1;

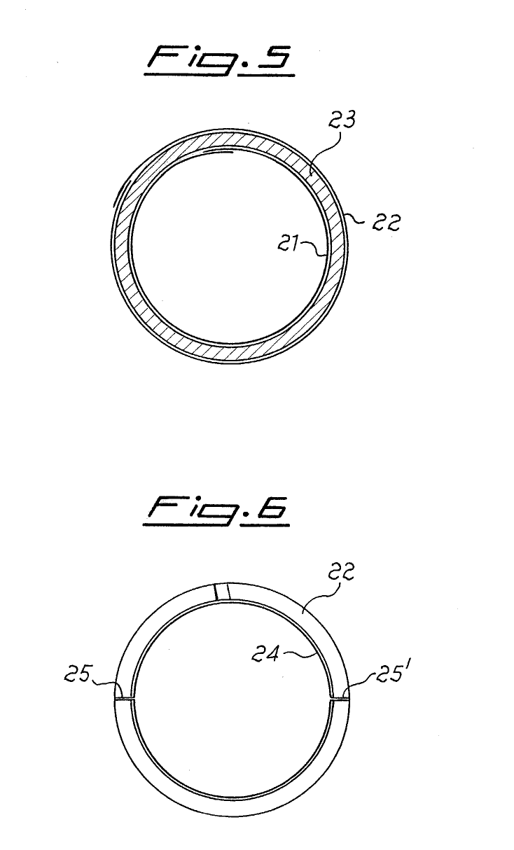

FIG. 3 shows a frontal view of the thermoinsulating device of FIG. 1;

FIG. 4 shows a perspective view of the thermoinsulating device according to a second embodiment of the present invention;

FIG. 5 shows a cross-sectional view of the thermoinsulating device of FIG. 4;

FIG. 6 shows a frontal view of the thermoinsulating device of FIG. 4;

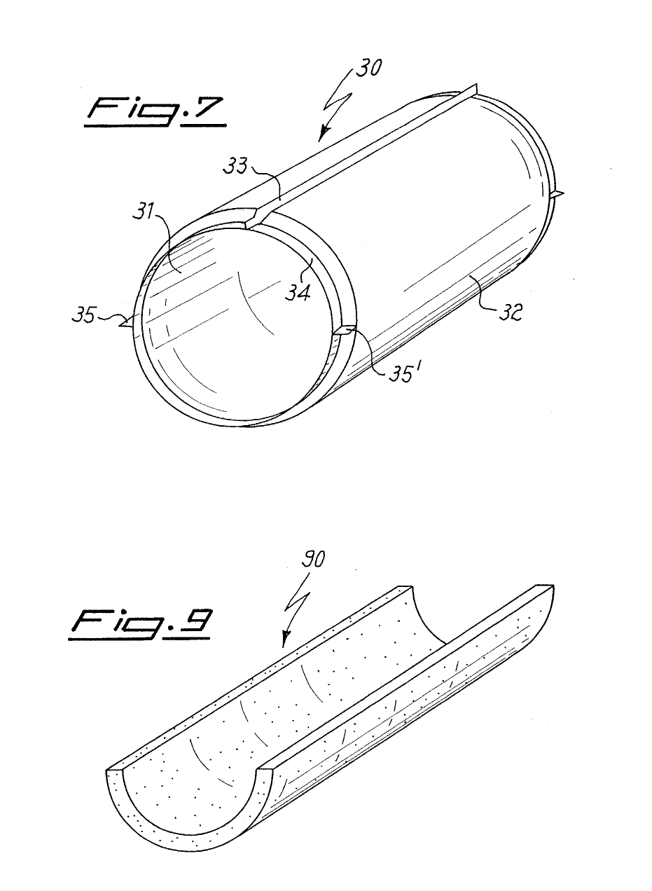

FIG. 7 shows a perspective view of the thermoinsulating device according to a third embodiment of the present invention;

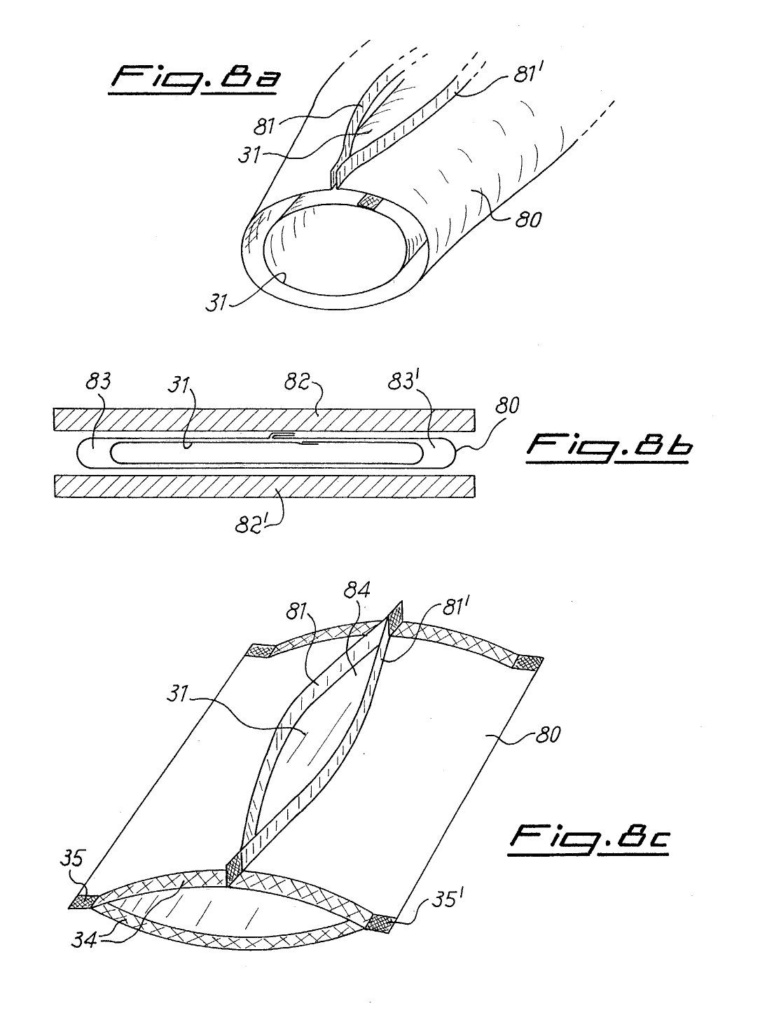

FIG. 8 shows the main steps of the process for manufacturing the device according to FIG. 7; and

FIG. 9 shows a shape of the filling material that can be used in a process according to the invention.

In a first aspect thereof, the invention relates to a tubular thermoinsulating device.

In FIGS. 1 to 3 there is shown a tubular thermoinsulating device 10 corresponding to a first embodiment of the invention. The thermoinsulating device 10 comprises in a known way an envelope, formed of an internal tubular element 11 and an external tubular element 12 inserted one in the other, inside which is housed an inorganic or polymeric, discontinuous or porous filling material 13. According to this embodiment, each one of the tubular elements 11 and 12 is formed starting from a multilayer barrier sheet whose opposite faces are made of different materials which are not reciprocally thermo-weldable. For example, a typical multilayer barrier sheet may comprise in sequence an HDPE layer, an aluminum layer and a nylon layer; in this case the opposite margins which are welded together will be located on the face covered with HDPE which ensures a more stable welding with respect to nylon. Therefore, said face covered with HDPE will be turned outwards in the case of the internal tubular element 11 and inwards in the case of the external tubular element 12. In a tubular element so produced, in the welding area is formed a flange (shown in FIGS. 1-3 as element 14 in the case of the internal tubular element 11, and as element 15 in the case of the external tubular element 12). Further, also the sealing of the circular edges of the internal and external tubular elements 11 and 12 occurs between faces covered with the same material, as shown in FIG. 3. With the sealing of element 11 to element 12 two circular flanges 16 are formed. In FIG. 3 there is shown that said welding is made in such a way that said circular edges of the two elements 11 and 12 completely adhere to each other in the area wherein they are joined, and that on the wider circular edges of the external tubular element 12, two diametrically opposite plies 17, 17′ have been made by welding a small portion of element 12 on itself: these two plies 17, 17′ enable the size of element 12 to be adapted to that of element 11. The sealing of the circular edges and the formation of plies 17, 17′ can be made in a simple and quick way by thermo-welding with rectilinear welding bars, as described in detail in the following with reference to the process according to the invention.

In FIGS. 4 to 6 there is shown a tubular device 20 according to another embodiment of the present invention, which also comprises an envelope inside which is inserted a thermoinsulating inorganic or polymeric, discontinuous or porous filling material 23. The envelope comprises an internal tubular element 21 and an external tubular element 22 inserted one in the other and welded at their circular edges, with the formation of two circular flanges 24.

As shown in FIG. 5, also in this case each one of the internal and external tubular elements 21 and 22 is made by rolling a barrier sheet until two opposite margins thereof are joined and by welding together said margins by thermo-welding. However in this case the two opposite margins which are welded are located on opposite sides of the barrier sheet, so that the sealing is flat and no flanges protruding internally or externally of the tubular elements are present. In order to do that it is necessary that both sides of each barrier sheet are covered with layers of reciprocally thermo-weldable materials; this last condition is preferably obtained with barrier sheets wherein the two faces are formed of the same material, for example HDPE.

FIG. 6 shows that also in this case the sealing between the circular edges of the internal tubular element 21 and of the external tubular element 22 is such that said edges completely adhere to each other and the circular flange 24 formed by the junction thereof is free from wrinkles. Two diametrically opposite plies 25, 25′ have been made on each one of the circular edges of the external tubular element 22 in order to adapt it to the circular edges of the internal tubular element 21.

Also in this case, the sealing of the circular edges and the formation of said plies 25, 25′ are made at the same time by means of thermo-welding with rectilinear welding bars, as described in the following.

Finally, FIG. 7 shows in a perspective view a third possible tubular device 30 according to the present invention. In this case, the envelope is formed of an internal tubular element 31 made according to the modality of device 20, that is by superimposing two margins of opposite faces of a multi-layer barrier sheet, whereas the external tubular element 32 is made according to the modality of device 10, that is, by superimposing two margins of the same face of a barrier sheet and forming an external flange 33; also in this case element 32 is provided, along circular flange 34, with two plies 35, 35′, which reduce the size of element 32 to the size of element 31, thus allowing the perfect welding of the two elements. A device of the type 30 offers the advantage that no flange turned towards the inside of the device is provided (such as flange 14 in device 10), thus allowing a better contact between the device and the body to be thermally insulated and consequently increasing the efficacy of the insulation; on the other side, the device of type 30 offers a constructive advantage as described in the following.

All these devices (10; 20; 30) can contain a getter material or device, of a type known in the field, for maintaining the desired degree of vacuum in time.

In a second aspect thereof, the invention relates to two possible processes for manufacturing the tubular devices of type 10, 20, or 30.

A first process may be used in the manufacture of tubular devices wherein the external tubular clement of the envelope is provided with a flange turned outwards; the above described devices 10 and 30 correspond to this type. The main steps of this process are schematized in FIGS. 8a-8c, and their description will be made with reference to the tubular device of the type 30, but it has to be understood that the same process has a general applicability. The process comprises the formation of an internal tubular element 31 and the preparation of a multilayer barrier sheet 80, of the type wherein the two opposite faces are not reciprocally thermo-weldable. Sheet 80 is rolled around element 31, arranging two margins 81, 81′ thereof face to face, but without carrying out in this step the longitudinal welding which will form flange 33 (FIG. 8a). The final edges of the assembly formed of element 31 and sheet 80 are thermo-welded by inserting them between two rectilinear bars 82 and 82′, as shown in FIG. 8b; since the sheet 80 has a greater circumference than element 31, the flattening between bars 82, 82′ is such that in the lateral areas 83, 83′, sheet 80 is not in contact with element 31, but rather that the two portions of the internal face of sheet 80 are in contact with each other. In order to prevent the two facing portions of element 31 from welding on themselves in this step, it is possible to put between them a sheet of a material which is not thermo-weldable, for example an aluminum sheet. In the case that a device of type 10 is desired, this last measure is not necessary if the material turned towards the inside of element 31 is not suitable for the thermo-welding, such as nylon. With the previous operation the circular flange 34 and, at areas 83, 83′, plies 35, 35′ are formed at the same time, by using rectilinear welding bars; the result is an intermediate product of the final envelope, shown in FIG. 8c. In this step the envelope is still provided with an opening 84; through said opening it is possible to insert into the envelope the filling material, in the form of two semi-cylindrical shells of the type 90, shown in FIG. 9, by letting them slide between element 31 and sheet 80; this shells can be made for example in rigid polyurethane foam. Finally, the still opened envelope containing the filling material is inserted into a vacuum chamber, the inside thereof is evacuated and the two hems 81, 81′ are thermo-welded together by using rectilinear welding bars, thus completing device 30.

In the case that the envelope is formed of an external tubular element of the type without an outwards turned flange, the process described up to now cannot be used. A device of this kind could be provided with a flange in the internal tubular element of the envelope, but preferably it is of the type 20, without such a flange; the following description will be referred to this device of preferred type. In order to make a device of the type 20, two finished tubular devices 21 and 22 (that is, having the longitudinal welding already done on both) are provided; element 21 is inserted inside element 22, and one end only of the assembly is inserted between the rectilinear welding bars, thus obtaining on just one side of the envelope flange 24 with plies 25. At the still opened end of the envelope is now inserted the filling material, which in this case can have the shape of a complete hollow cylinder. Finally, the last welding at the opposite end of the envelope is made under vacuum with traditional methods (for example, by sliding two welding heads along the circumference to be welded).

In all the variants of the process according to the invention, it is possible to insert a getter material or device inside the envelope before the last welding step.

Possible variations and additions can be made by those skilled in the art to the above described and illustrated embodiments by remaining within the invention itself.

1. A tubular thermoinsulating device (10; 20; 30), comprising an evacuated envelope, made of barrier sheets, inside which an inorganic or polymeric, discontinuous or porous filling material (13; 23) is contained, characterized in that said envelope comprises an internal tubular element (11; 21; 31) and an external tubular element (12; 22; 32) of higher diameter, which are coaxially arranged one inside the other and are reciprocally sealed at their circular edges, the circular edges of said external tubular element (12; 22; 32) being adapted to the circular edges of said internal tubular element (11; 21; 31) by means of two plies (17, 17′; 25, 25′; 35, 35′).

2. A tubular thermoinsulating device according to the preceding claim, characterized in that each one of said tubular elements (11, 12; 21, 22; 31, 32) is formed of at least one barrier sheet rolled and welded on itself along two opposite margins thereof.

3. A tubular thermoinsulating device according to the preceding claim, characterized in that the barrier sheets which form said tubular elements are multilayer sheets.

4. A tubular thermoinsulating device according to one of the preceding claims, characterized in that the opposite margins of a barrier sheet which are welded together are located on the same face of said barrier sheet.

5. A tubular thermoinsulating device according to one of claims 1 to 3, characterized in that the opposite margins of a barrier sheet which are welded together are located on opposite faces of said barrier sheet.

6. A tubular thermoinsulating device according to the preceding claim, characterized in that said barrier sheet is provided on the opposite faces thereof with layers of reciprocally thermo-weldable materials.

7. A tubular thermoinsulating device according to one of the preceding claims, characterized in that said filling material is formed of two semi-cylindrical shells (90) of an open-celled rigid polymeric foam.

8. A tubular thermoinsulating device according to one of the preceding claims, characterized in that it comprises a getter material or device arranged between the internal tubular element (11; 21; 31) and the external tubular element (12; 22; 32).

9. A process for manufacturing a tubular thermoinsulating device (10; 30), characterized in that it comprises the following steps:
forming an internal tubular element (11; 31) starting from a barrier sheet having a substantially rectangular shape;
rolling a second barrier sheet (80) around said element and coaxially thereto, by placing face to face two margins (81, 81′) of said second sheet;
inserting the ends of the assembly formed of the internal tubular element (11; 31) and of the sheet (80) between pairs of rectilinear welding bars (82, 82′) and carrying out a thermo-welding at said ends;
inserting two semi-cylindrical shells (90) of a filling material between said second sheet (80) and said internal tubular element (11; 31), through an opening (84) between said margins (81, 81′) of the second sheet;
inside an evacuated chamber, sealing said margins (81, 81′) by using two rectilinear welding bars.

10. A process according to claim 9 wherein, when the internal tubular element (31) is made of a multilayer barrier sheet whose opposite faces are reciprocally thermoweldable, before carrying out the thermo-welding of the ends of said assembly, a sheet of a material which is not thermo-weldable is inserted inside the tubular element (11; 31) at the welding bars (82, 82′).

11. A process for manufacturing a tubular thermoinsulating device (20), characterized in that it comprises the following steps:
forming an internal tubular element starting from a barrier sheet of rectangular shape by reciprocally welding two opposite margins thereof;
forming an external tubular element (22) starting from a barrier sheet of rectangular shape by reciprocally welding two opposite margins located on the opposite faces of said sheet;
inserting said internal tubular element into said external tubular element;
inserting a first end of the assembly formed of said tubular elements between rectilinear welding bars and carrying out a thermo-welding at said first end;
inserting a filling material between said tubular elements through the opening at the second end of said elements;
inside an evacuated chamber, sealing said second end by thermo-welding with traditional methods.

12. A process according to claim 11 wherein, when the internal tubular element (21) is made of a multilayer barrier sheet whose opposite faces are reciprocally thermo-weldable, before thermo-welding said first end of the assembly formed of said tubular elements, a sheet of a material which is not thermo-weldable is inserted inside the internal tubular element, at the welding bars.

13. A process according to one of the preceding claims wherein, before the last sealing operation, a getter material or device is inserted inside the envelope.
